(19) United States
(12) Patent Application Publication
(10) Pub. No.: US 2021/0299491 A1
(43) Pub. Date: Sep. 30, 2021

(54) METHOD AND DEVICE FOR FIRE SUPPRESSION IN AN ENERGY STORAGE UNIT

(71) Applicant: EmberTech, LLC, MACON, GA (US)

(72) Inventors: KAYYANI C ADIGA, MACON, GA (US); RAJANI ADIGA, MACON, GA (US); Herbert Wayne Graves, MACON, GA (US)

(21) Appl. No.: 17/206,166

(22) Filed: Mar. 19, 2021

Related U.S. Application Data
(60) Provisional application No. 62/994,679, filed on Mar. 25, 2020.

(51) Int. Cl. A62C 2/04; H01M 10/0525; H01M 10/42; H01M 10/52; A62C 3/16

(52) U.S. Cl. CPC A62C 2/04; H01M 10/0525; H01M 2200/00; H01M 10/523; A62C 3/16; H01M 10/4235

(57) ABSTRACT

The present disclosure provides a method and a device for suppressing fire due to combustible gases generated from an energy storage unit. The device includes a substrate (102), a catalyst (103) coated on the substrate (102) and the catalyst coated substrate (101) placed with the energy storage unit for suppressing raging fire.

The present application is filed as a non-provisional application claiming the priority of the provisional application bearing application No. 62/994,679, filed on Mar. 25, 2020.

### FIELD

The embodiments herein generally relate to suppressing fire due to combustible gases generated from an energy storage unit, preferably, Lithium-ion battery. More particularly, the disclosure relates to a method and a device for suppressing fire from an energy storage unit without releasing flammable gaseous products.

### BACKGROUND AND PRIOR ART

Lithium-ion Battery Energy Storage Systems (ESS) are the primary power source for wind turbine farms, solar farms, and many other facilities requiring high electrical power. Besides stationary ESS, there are other important Li-ion battery applications including mobile ESS in electric automobiles, trucks, and many electronic gadgets such as laptops, games and electronic smoking devices.

However, Li-ion batteries are vulnerable to failures and fires due to direct external heating, mechanical failures, physical damage, manufacturing defect, over-charge, over-discharge, thermal failures, overheating, and internal localized heating. The root cause of Li-ion battery fire is due to initiation of heat buildup inside the battery for several reasons. Plastic used for encasing the battery and the spacers are also a source of generation of additional heat within the battery.

Li-ion battery produces highly flammable combustible gases generating significant heat upon exposure to ignition. In addition to Class C electrical fires, Class B fires are generated from thermal runaway which require cooling along with fire suppression agent to prevent reflash.

Conventionally, sprinklers are used as fire suppression agent for delaying or preventing fire spreading to adjacent racks of Lithium-ion batteries. However, regular water mist or sprinklers cannot reach these batteries which are placed inside cabinets placed on racks because of congested and convoluted flow paths. Moreover, since water is conductive it can cause short-circuiting of cell-to-cell and produce mass flow of flame gases. Further, cooled tubes are used as a prevention system for continuously cooling the lithium-ion batteries without direct impinging of water on cells (cooled tubing's). However, this is expensive, inconvenient, and often inadvertent cause of failure of cooling or a spark/arc may cause thermal runaway condition. Further, it may result in huge ESS fires and tube cooling may not put out fire. Air cooling is also used for preventing fires in Lithium-ion batteries, however, often a spark or an arc may trigger fire and may not be able to control the fire.

Stationary ESS systems are typically protected by multiple layers of fire protection including water-based sprinkler systems, gaseous systems such as FM200 and localized rack fire protection such as Fire Trace. All these are active post event suppression methods. For mobile ESS such as in electric vehicles there are no protection systems at the present.

Therefore, there is a need for controlling and suppressing fire generated in any type of energy storage units or systems. Moreover, there is a need for a method and device for suppressing fire due to combustible gases generated from energy storage units without releasing flammable gaseous products.

### OBJECTS

Some of the objects of the present disclosure are described herein below:

The main objective of the present disclosure is to provide a method and device for reducing heat, flames, toxic and flammable gases produced from energy storage units at a source.

Another objective of the present disclosure is to provide a catalyst with low activation energy for low temperature surface glowing process and preventing raging fires.

Still another objective of the present disclosure is to provide an arrangement of a catalyst coated substrate on any type of energy storage unit without requiring additional modifications for suppressing fire.

Yet another objective of the present disclosure is to provide a method and a device for suppressing fire due to combustible gases generated from energy storage without releasing toxic and flammable gases.

The other objectives and advantages of the present disclosure will be apparent from the following description when read in conjunction with the accompanying drawings, which are incorporated for illustration of preferred embodiments of the present disclosure and are not intended to limit the scope thereof.

### SUMMARY

In view of the foregoing, an embodiment herein provides a method and device for fire suppression in an energy storage unit.

In accordance with an embodiment, the device comprises of a substrate, a catalyst coated on the substrate and the catalyst coated substrate placed with the energy storage unit for suppressing fire. In an embodiment, the energy storage unit is a Lithium-ion battery.

In accordance with an embodiment, the catalyst coated substrate is placed above a plurality of energy storage units provided in a battery rack for suppressing fire from each of the energy storage units.

In accordance with an embodiment, the catalyst coated substrate is placed above a safety vent of plurality of energy storage units provided in an energy storage unit array for suppressing fire generated from each of the energy storage units of the energy storage unit array.

In accordance with an embodiment, the catalyst coated substrate is placed above a safety vent at a positive terminal of the energy storage unit for suppressing fire due to combustible gases generated from the energy storage unit.

In accordance with an embodiment, a shape and size of the catalyst coated substrate is based on the energy storage unit and placing of the catalyst coated substrate relative to the energy storage unit.

In accordance with an embodiment, the substrate is selected from a group consisting of stainless steel, ceramic and a non-combustible material. In an embodiment, a structure of the substrate is selected from a group consisting of honeycomb structure, foam structure and a porous structure.

In accordance with an embodiment, the catalyst is selected from a group consisting of Platinum, Palladium, transition metal oxide and alloys of Platinum, Palladium.

In accordance with an embodiment, the method for suppressing fire in an energy storage unit comprises the steps of providing a substrate, coating a catalyst on the substrate and placing the catalyst coated substrate with the energy storage unit. In an embodiment, the catalyst coated substrate reacts with combustible gases generated from the energy storage unit at a temperature in a range of 200° to 500° C. for producing fumes and a glowing surface of the catalyst coated substrate, thereby suppressing fire.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF DRAWINGS

The detailed description is set forth with reference to the accompanying figures. In the figures, the left-most digit(s) of a reference number identifies the figure in which the reference number first appears. The use of the same reference numbers in different figures indicates similar or identical items.

FIG. 1a illustrates a catalyst coated substrate for suppressing fire in an energy storage unit, according to an embodiment herein;

FIG. 1b illustrates a catalyst coated substrate inserted in a rack above the battery array for suppressing fire in an energy storage unit, according to an embodiment herein;

FIG. 2 illustrates an energy storage system using catalyst coated substrate for suppressing fire, according to an embodiment herein;

FIG. 3a illustrates a three-dimensional view of internal structure of an energy storage unit including the catalyst coated substrate, according to an embodiment herein;

FIG. 3b illustrates a two-dimensional view of internal structure of an energy storage unit including a catalyst coated substrate, according to an embodiment herein;

FIG. 4 illustrates a two-dimensional view of an energy storage unit without a catalyst coated substrate and with a catalyst coated substrate, according to an embodiment herein;

FIG. 5 illustrates a two-dimensional view of an energy storage unit array with a catalyst coated substrate, according to an embodiment herein;

FIG. 6a illustrates fire generated in an energy storage unit without a catalyst coated substrate, according to an embodiment herein;

FIG. 6b illustrates fire generated in an energy storage unit with a catalyst coated substrate, according to an embodiment herein; and

FIG. 7 illustrates a graph showing temperature plots of fire and glowing surface generated in an energy storage unit with a catalyst coated substrate and without a catalyst coated substrate, according to an embodiment herein.

### LIST OF NUMERALS

101—Catalyst coated substrate
102—Substrate
103—Catalyst
104—Battery rack
105—Plurality of energy storage units
201—Battery tray
301—Positive terminal
302—Safety vent
303—Metal casing
304—Separator
305—Cathode
306—Aluminum
307—Copper
308—Anode
309—Center pin
310—Electrodes
314—Through holes
316—Vent disc
320—Combustible gases
401—Energy storage unit without catalyst coated substrate
402—Positive terminal
403—Energy storage unit with catalyst coated substrate
404—Positive terminal
501—Energy storage unit array
601—Fire with flames
602—Fumes without flames

### DETAILED DESCRIPTION OF THE PREFERRED EMBODIMENTS

The embodiments herein and the various features and advantageous details thereof are explained more fully with reference to the non-limiting embodiments and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

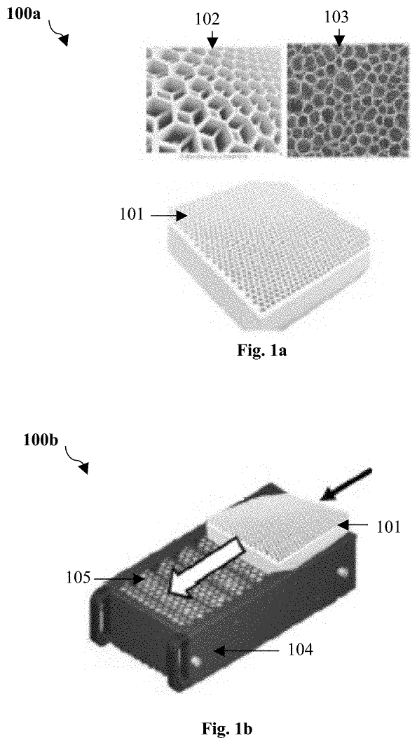

As mentioned above, there is a need for controlling and suppressing fire generated in energy storage units preferably Lithium-ion battery. In particular, there is a need for a method and device for suppressing fire caused due to combustible gases generated from an energy storage unit without releasing flammable and toxic gaseous products, and without requiring modification of existing energy storage units. The embodiments herein achieve this by providing “Method and Device for Fire Suppression in an Energy Storage Unit”. Referring now to the drawings, and more particularly to FIG. 1 through FIG. 7, where similar reference characters denote corresponding features consistently throughout the figures, there are shown preferred embodiments.

FIG. 1a illustrates a catalyst coated substrate for suppressing fire in a Lithium-ion battery. A catalyst coated substrate 101 is provided as a block for suppressing fire in an energy storage unit. The catalyst coated substrate includes a substrate matrix 102 and a catalyst matrix 103, wherein the catalyst is coated on the substrate 102. In an embodiment, the substrate includes but not limited to Stainless steel, Ceramic, any non-combustible material. The substrate is provided in a structure including but not limited to honeycomb structure, foam structure, any porous structure.

In an embodiment, honeycomb structure of the substrate is provided with density in a range of 7.5 g/ft³ to 60 g/ft³ and a corresponding cells per square inch (CPSI) for providing suitable flow resistance and residence time of catalytic reaction of the catalyst.

In an embodiment, the catalyst 103 is coated on a surface of the substrate. The catalyst is provided for reacting with combustible and flammable gases generated in an energy storage unit at a reduced temperature. The catalyst reacts with combustible and flammable gases wherein flame of the fire is transitioned into a glowing surface at a reduced temperature and energy, thereby suppressing the raging fire and preventing spreading of the fire from the energy storage unit. The catalyst generates combusted products as fumes that are relatively non-toxic and non-flammable due to reaction at a low temperature.

In an embodiment, a catalyst having a composition with an extremely low activation or “light off temperature” is desirable for causing fast transition from flaming fire to a glow with fumes at a lower temperature.

In an embodiment, a thin layer of catalyst is coated on the substrate by chemical vapor deposition, or any suitable method of surface coating. In an embodiment, range of thickness of the thin layer is between nano and micron.

In an embodiment, the catalyst includes but not limited to Platinum, Palladium, transition metal oxide, alloys of Platinum, Palladium. In an embodiment oxidation catalyst is coated, wherein the oxidation catalyst includes but not limited to Cerium oxide and transition metal oxides.

In an embodiment, structure of the catalyst may be rigid if ceramic substrate is used. The structure of the catalyst may be flexible if non-combustible substrates are used. In an embodiment, geometry, dimensions, cell density, block density of the catalyst coated substrate are based on an application.

In an embodiment, the energy storage unit, hereinafter referred to as ESU, includes but not limited to a battery, a Lithium-ion battery, any type of battery irrespective of structure, chemistry, size.

In an embodiment, the catalyst coated substrate 101 is placed with the ESU for suppressing fire. In an embodiment, placing of the catalyst coated substrate 101 relative to the ESU is based on the ESU, a structure of the ESU and number of ESUs. In a preferred embodiment, the catalyst coated substrate 101 is placed above the ESU.

FIG. 1b illustrates a catalyst coated substrate inserted above a battery rack for suppressing fire in an energy storage unit. A battery rack 104 is provided, wherein a plurality of ESUs 105 are stored in the battery rack 104. In an embodiment, the ESUs 105 are batteries, preferably Lithium Ion batteries.

The catalyst coated substrate 101 for a battery rack 104 is placed above the ESUs 105 for suppressing raging fire due to combustible and flammable gases generated from any one of the ESUs 105. Size of the catalyst coated substrate 101 is based on a size of the battery rack 104 for covering all the ESUs 105 placed in the battery rack 104.

In an embodiment, the catalyst coated substrate 101 is reused in a fire suppression process.

The fire caused due to combustible and flammable gases generated from the ESU increases temperature of the catalyst coated substrate 101, wherein the catalyst reaches its minimum reaction temperature or “light off” temperature between 200° C. to 500° C. On reaching the minimum reaction temperature, catalyst on surface of the substrate reacts at a lower temperature between 200° C. and 500° C., thereby not generating toxic and flammable gaseous products. The reaction transitions from flames to a glowing surface of the catalyst coated substrate producing fumes and not spreading the fire.

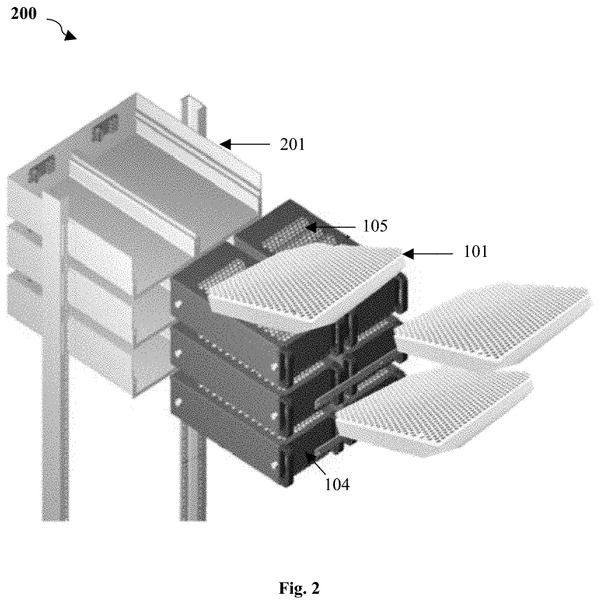

FIG. 2 illustrates an energy storage system using catalyst coated substrate for suppressing fire. An energy storage system includes a plurality of battery trays 201 for housing the battery rack 104. The battery trays 201 include provisions for housing a plurality of battery racks 104 wherein each battery rack 104 includes a plurality of ESUs 105. The catalyst coated substrate 101 is placed above each battery rack 104 for suppressing fire to be caused by the combustible and flammable gases generated from an ESU in the battery rack 104. Thereby, the catalyst coated substrate 101 suppresses raging fire and prevents spreading of the fire from one battery rack to another battery rack.

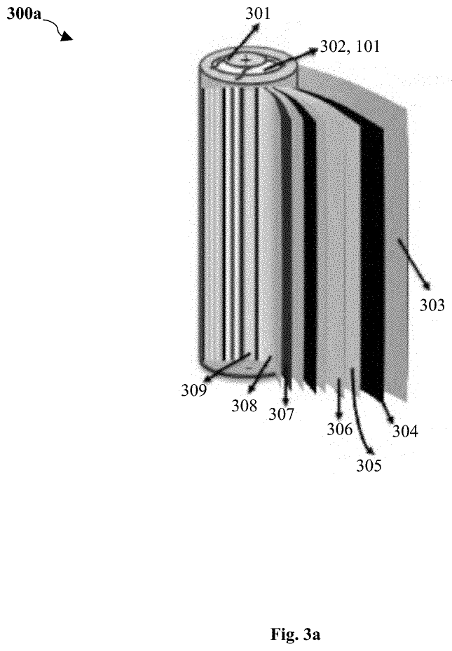

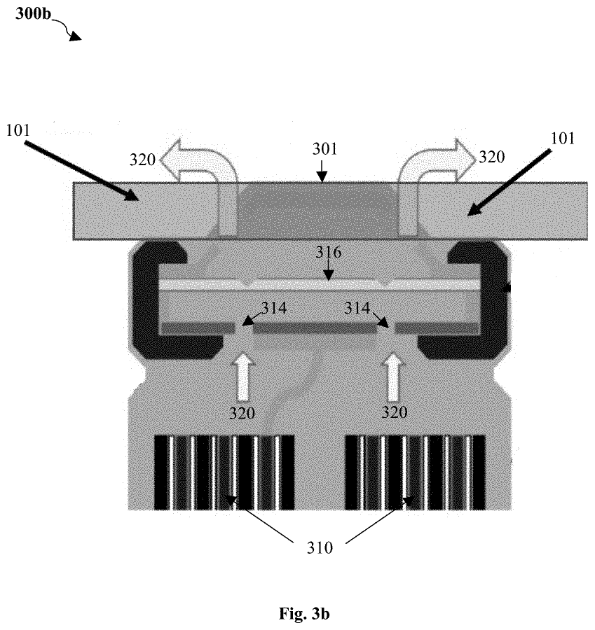

FIG. 3a illustrates a three dimensional view of internal structure of an energy storage unit including the catalyst coated substrate. In an embodiment, the ESU is a conventional Lithium-ion cell 300a including a positive terminal 301, a safety vent 302, a metal casing 303, a separator 304, a cathode 305, an Aluminum element 306, a Copper element 307, an anode 308, a center pin 309.

In an embodiment, the catalyst coated substrate 101 for a single ESU requires a placement and structure for effectively suppressing combustible gases. In an embodiment, ideally, the catalyst coated substrate 101 is placed around the safety vent 302. The safety vent 302 is provided in the ESU for releasing gases built up inside the battery/cell. The gases built up inside the ESU are generally combustible gases that are a main source of fire.

In an embodiment, the catalyst coated substrate 101 is placed above the vent 302 for suppressing fire caused due to combustible gases generated at the source, thereby preventing spread of fire. In an embodiment, the catalyst coated substrate 101 is provided in a shape based on a shape of the safety vent 302. Conventionally, shape of the safety vent 302 is an annular groove provided around the positive terminal 301. The catalyst coated substrate 101 is provided in a toroidal shape for being placed above the annular groove of the safety vent 302 around the positive terminal 301.

FIG. 3b illustrates a two-dimensional view of internal structure of an energy storage unit including a catalyst coated substrate and a flow of heat and gases after explosion inside the ESU. In an embodiment, the ESU is a Lithium Ion battery. The Lithium-ion battery includes a plurality of electrodes 310. Explosion inside the Lithium-ion battery generates heat and combustible gases 320. A plurality of through holes 314 is provided for allowing flow of the gases 320. The gases 320 pass through a vent disk 316 and flow out of the battery through plurality of safety vents around the positive terminal 301. The flowing gases 320 are highly combustible and react outside the battery thereby generating fire. The catalyst coated substrate 101 is placed above the safety vent at the positive terminal 301 for reacting with the flowing combustible gases 320 at a lower temperature and lower energy. The combustible gases react on the catalyst matrix of the catalyst coated substrate at a lower temperature, producing white gaseous fumes that are not flammable.

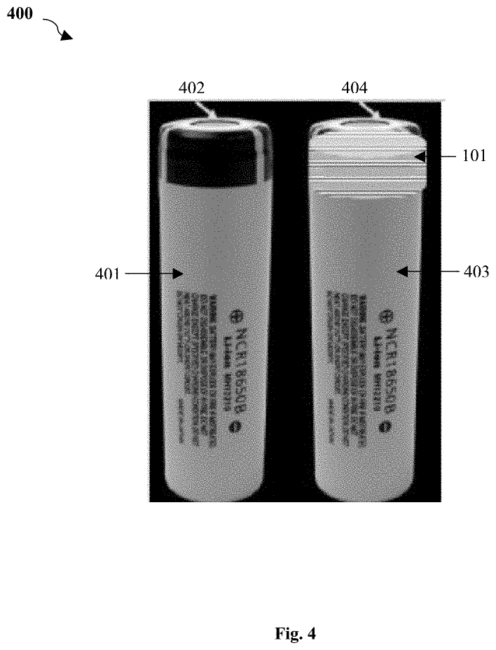

FIG. 4 illustrates a two-dimensional view of an energy storage unit without a catalyst coated substrate and with a catalyst coated substrate. In an embodiment, a single Lithium-ion battery 401 is shown without the catalyst coated substrate. The Lithium-ion battery 401 includes a positive terminal 402. In an embodiment, a single Lithium-ion battery 403 is provided wherein the Lithium-ion battery 403 includes a positive terminal 404. The catalyst coated substrate 101 is placed above the safety vent of the battery 403. The catalyst coated substrate 101 does not cover the positive terminal 404 of the battery.

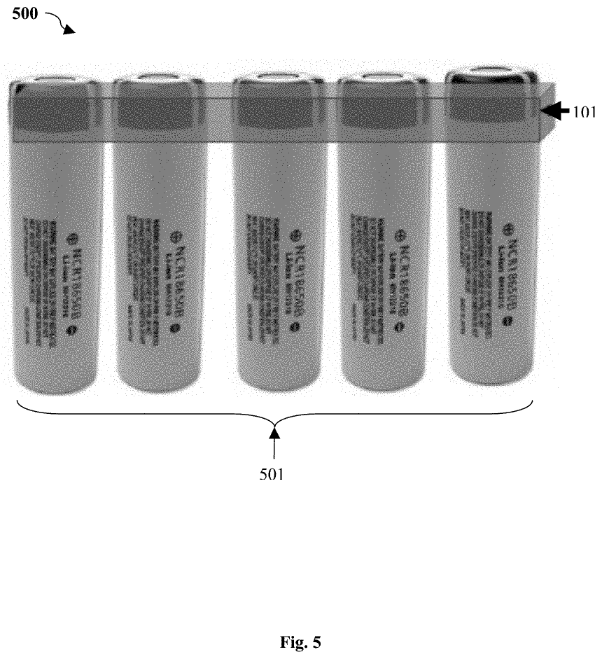

FIG. 5 illustrates a two-dimensional view of an energy storage unit array with a catalyst coated substrate. A battery array 501 includes a plurality of ESUs. In an embodiment, the ESUs are batteries. The catalyst coated substrate 101 is provided for placing above the vent of each battery in the battery array 501. Shape and size of the catalyst coated substrate is based on the safety vent of each battery and dimensions of the battery array 501.

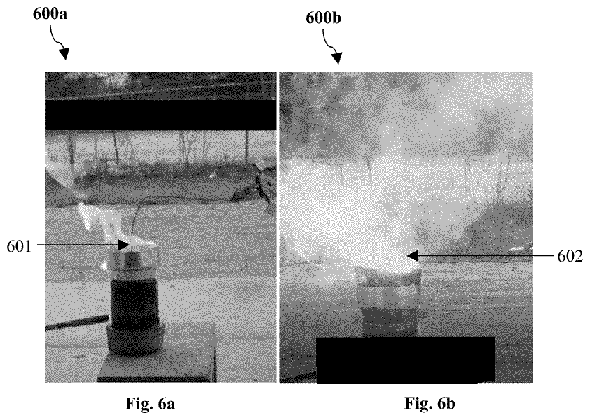

FIG. 6a illustrates fire generated in an energy storage unit without catalyst and FIG. 6b illustrates fire generated in an energy storage unit with catalyst. FIG. 6a shows fire with visible flame 601 generated from a Lithium-ion battery without the catalyst coated substrate. FIG. 6b shows white fumes without flames 602 generated from the Lithium-ion battery with the catalyst coated substrate. The white fumes are produced at a lower temperature and lower energy, thereby suppressing spreading of raging fire. The white fumes do not include flammable and combustible gases due to reaction of the catalyst at a lower temperature.

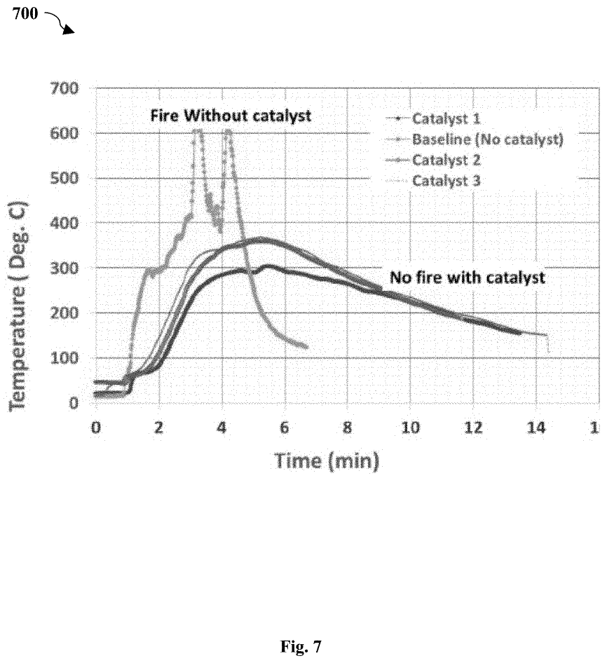

FIG. 7 illustrates a graph showing temperature plots of fire generated in a Lithium-ion battery without a catalyst coated substrate and temperature plots of glowing surface generated in a Lithium-ion battery with a catalyst coated substrate. The graph is plotted with time in minutes on the X-axis and temperature in degree Celsius on the Y-axis. The graph is based on the fire generated in FIG. 6a without catalyst coated substrate and white fumes generated in FIG. 6b with catalyst coated substrate. Fire generated in the Lithium-ion battery without the catalyst coated substrate reaches temperatures greater than 600° C. within 4 minutes. The actual temperature may be higher as thermocouples used for measuring the temperature appeared coated with carbon and soot.

However, white fumes generated from the catalyst coated substrate in the Lithium-ion battery does not cross temperature more than 400° C. at any point of time, as the white fumes are produced from reaction of the catalyst occurring at a lower temperature (based on minimum reaction temperature of the catalyst). The catalyst coated substrate prevents production of toxic and flammable gases during combustion due to lower temperature of reaction.

In an embodiment, the method and device described is not limited to controlling and suppressing fires generated in ESUs. The method and device can be used in various applications including but not limited to various fires such as in data center by combining total flooding and catalyst coated substrates in servers, library, and any fires on fixed structures. Other applications may include but not limited to fuel tank protection, automotive battery protection.

A main advantage of the present disclosure is that the method and device provides suppression of fire caused due to combustible gases generated in ESUs without releasing flammable and toxic gases.

Another advantage of the present disclosure is that the method and device provides suppression of fire in ESUs at a source, thereby preventing damage of the batteries.

Still another advantage of the present disclosure is that the method and device provides eco friendly suppression of fire in ESUs releasing non flammable and combusted products.

Yet another advantage of the present disclosure is that the method and device provides suppression of fire in ESUs at a lower temperature and reduced energy.

Another advantage of the present disclosure is that the device for suppression of fire in ESUs is reusable.

Still another advantage of the present disclosure is that the method and device provides fire suppression in ESUs irrespective of battery brand, structure, chemistry of the ESUs.

Yet another advantage of the present disclosure is that the method and device provides simple and advanced fire suppression for ESUs, without requiring any modification of the ESUs or batteries

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

We claim:

1. A device for suppressing fire in an energy storage unit, comprising:
a substrate (102):
a catalyst (103) coated on the substrate (102); and
the catalyst coated substrate (101) placed with the energy storage unit for suppressing fire.

2. The device as claimed in claim 1, wherein the catalyst coated substrate is placed above a plurality of energy storage units (105) provided in a battery rack (104) for suppressing fire from each of the energy storage units (105).

3. The device as claimed in claim 1, wherein the catalyst coated substrate (101) is placed above a safety vent of plurality of energy storage units provided in an energy storage unit array (501) for suppressing fire generated from each of the energy storage units of the energy storage unit array (501).

4. The device as claimed in claim 1, wherein the catalyst coated substrate (101) is placed above a safety vent (302) of the energy storage unit for suppressing fire due to combustible gases generated from the energy storage unit.

5. The device as claimed in claim 1, wherein a shape and size of the catalyst coated substrate (101) is based on the energy storage unit and placing of the catalyst coated substrate (101) relative to the energy storage unit.

6. The device as claimed in claim 1, wherein the substrate is selected from a group consisting of stainless steel, ceramic and a non-combustible material.

7. The device as claimed in claim 1, wherein a structure of the substrate is selected from a group consisting of honeycomb structure, foam structure and a porous structure.

8. The device as claimed in claim 1, wherein the catalyst is selected from a group consisting of Platinum, Palladium, transition metal oxide and alloys of Platinum, Palladium.

9. The device as claimed in claim 1, wherein the energy storage unit is a Lithium-ion battery.

10. A method for suppressing fire in an energy storage unit, comprising the steps of:
providing a substrate (102);
coating a catalyst (103) on the substrate (102); and
placing the catalyst coated substrate (101) with the energy storage unit.

11. The method as claimed in claim 10, wherein the catalyst coated substrate reacts with combustible gases generated from the energy storage unit at a temperature in a range of 200° C. to 500° C. for producing fumes and a glowing surface of the catalyst coated substrate (101), thereby suppressing fire.
